(19) United States
(12) Patent Application Publication
(10) Pub. No.: US 2014/0126853 A1
(43) Pub. Date: May 8, 2014

(54) MICRO-RING RESONATOR

(71) Applicants: Zhen Peng, Foster City, CA (US); Raymond G. Beausoleil, Redmond, WA (US)

(72) Inventors: Zhen Peng, Foster City, CA (US); Raymond G. Beausoleil, Redmond, WA (US)

(21) Appl. No.: 14/125,025

(22) PCT Filed: Jun. 15, 2011
(86) PCT No.: PCT/US2011/040559

§ 371 Date: Dec. 9, 2013

(51) Int. Cl. G02F 1/01

(52) U.S. Cl. CPC G02F 1/0118
USPC 385/2

(57) ABSTRACT

A micro-ring resonator includes a bus optical waveguide and a circular optical waveguide positioned adjacent to the bus optical waveguide so as to provide evanescent coupling of light between the waveguides. The cladding of the circular optical waveguide comprises an electro-optic polymer with an index of refraction that can be changed through application of an electric field.

### BACKGROUND

A photonic integrated circuit is a device that integrates multiple photonic components onto a single chip. Photonic components, as opposed to electrical components, operate with optical signals, e.g., signals having optical wavelengths. Optical wavelengths typically range from 850 nanometers (nm) to 1650 nm.

The various components that comprise a photonic circuit may include optical waveguides, optical amplifiers, lasers, and detectors. These components may be used for optical networks that utilize Wavelength Division Multiplexing (WDM) technology. WDM technology allows for transmission of several wavelengths of light through a single optical fiber. This provides several channels of communication across that single fiber and thus allows for a greater bandwidth. Bandwidth refers to the amount of data that can be transferred during a particular unit of time.

One type of optical component that may be used in photonic circuitry is a micro-ring resonator. A micro-ring resonator is a circular optical waveguide that is placed adjacent to a bus optical waveguide. A bus optical waveguide may propagate multiple wavelengths of light. The micro-ring resonator can be used to remove or filter out specific wavelengths of light propagating through an optical waveguide, such as the bus optical waveguide. This is useful in cases where multiple wavelengths of light are propagating through the waveguide as is the case with WDM systems. When the circular optical waveguide is placed appropriately, light of a particular wavelength propagating through the bus waveguide will be coupled into the micro-ring resonator. Thus, that wavelength of light is filtered out of the bus optical waveguide.

### BRIEF DESCRIPTION OF THE DRAWINGS

The accompanying drawings illustrate various examples of the principles described herein and are a part of the specification. The drawings are merely examples and do not limit the scope of the claims.

FIG. 1 is a diagram showing illustrative micro-ring resonators, according to one example of principles described herein.

FIG. 2 is a diagram showing an illustrative polymer modulated micro-ring resonator, according to one example of principles described herein.

FIG. 3 is a diagram showing an illustrative cross sectional view of the polymer modulated micro-ring resonator, according to one example of principles described herein.

FIGS. 4A and 4B are diagrams showing an illustrative process for placing electro-optic polymer onto micro-ring resonators, according to one example of principles described herein.

FIG. 5 is a flowchart showing an illustrative method for micro-ring resonator modulation, according to one example of principles described herein.

Throughout the drawings, identical reference numbers designate similar, but not necessarily identical, elements.

### DETAILED DESCRIPTION

As mentioned above, one type of optical component that may be used in photonic circuitry is a micro-ring resonator formed of a circular optical waveguide that can be used to remove a particular wavelength of light from propagating in an adjacent bus optical waveguide.

Optical waveguides, including micro-ring resonators, are formed by a first optically transparent material surrounded by a second optically transparent material with a lower index of refraction than the first optically transparent material. The outer material is referred to as the cladding.

Various characteristics of the micro-ring will determine which wavelength of light will be filtered from an adjacent optical bus waveguide. These characteristics included the length of the perimeter of the waveguide as well as the refractive index of the materials comprising the micro-ring resonator.

The micro-ring resonator can also be controlled so that it selectively does or does not extract light of a particular wavelength from the adjacent bus optical waveguide. By way of terminology, when the micro-ring resonator is “on”, it will remove the appropriate wavelength of light from the adjacent bus optical waveguide. When the micro-ring resonator is “off” it will no longer remove that specific wavelength from the adjacent bus optical waveguide and light of that wavelength will continue propagating in the adjacent bus optical waveguide past the micro-ring resonator as if the resonator where not there.

The process of turning the micro-ring resonator “on” and “off” is referred to as modulation. Thus, modulation of the micro-ring resonator allows for the selective filtering of a corresponding wavelength of light out of a bus waveguide. For example, in a normal state, the micro-ring resonator may remove light of a particular wavelength from the adjacent bus optical waveguide. The frequency of the light associated with this wavelength is referred to as the resonant frequency of the micro-ring resonator. Light propagating through an adjacent bus optical waveguide at the frequency that will be filtered out by the micro-ring resonator is said to be on resonance with the micro-ring. However, under certain conditions, the micro-ring resonator may be modulated so that it no longer removes light of that particular wavelength from the adjacent bus optical waveguide. This modulation can be used for a variety of purposes including encoding data into an optical signal at a corresponding wavelength in the bus optical waveguide.

The present specification discloses a method for modulating a micro-ring resonator. According to certain illustrative examples, a micro-ring resonator may be modulated by forming the cladding of the circular waveguide with an electro-optic polymer. An electro-optic polymer is a material that exhibits changes in its optical properties in response to particular electrical conditions. Particularly, the refractive index of certain electro-optic polymers can be changed through application of an electric field. Thus, metal contacts can be placed around the micro-ring resonator. When a voltage is applied between those two metal contacts, an electric field will exist between the metal contacts. This electric field can change the refractive index of the electro-optic polymer and therefore the effective refractive index of the micro-ring resonator. This will make it so a particular wavelength of light that would normally be accepted into the micro-ring resonator is no longer resonant with the micro-ring resonator. If light is not resonant with the micro-ring resonator, then that light will not couple into the micro-ring resonator from the bus waveguide. Thus, that light will propagate through the bus waveguide as though the micro-ring resonator were not present.

Through use of methods and systems embodying principles described herein, an efficient manner of modulating a micro-ring resonator may be realized. By modulating the effective refractive index of the resonator with an electric field, minimal electrical current will flow and thus very little power is consumed. Additionally, deposition of the electro-optical polymer is compatible with standard integrated circuit manufacturing processes and thus production of photonic circuits utilizing micro-ring resonators is made less costly. Furthermore, silicon micro-rings possess small footprints and good optical mode confinement. This results in more efficient modulation and higher integration density.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

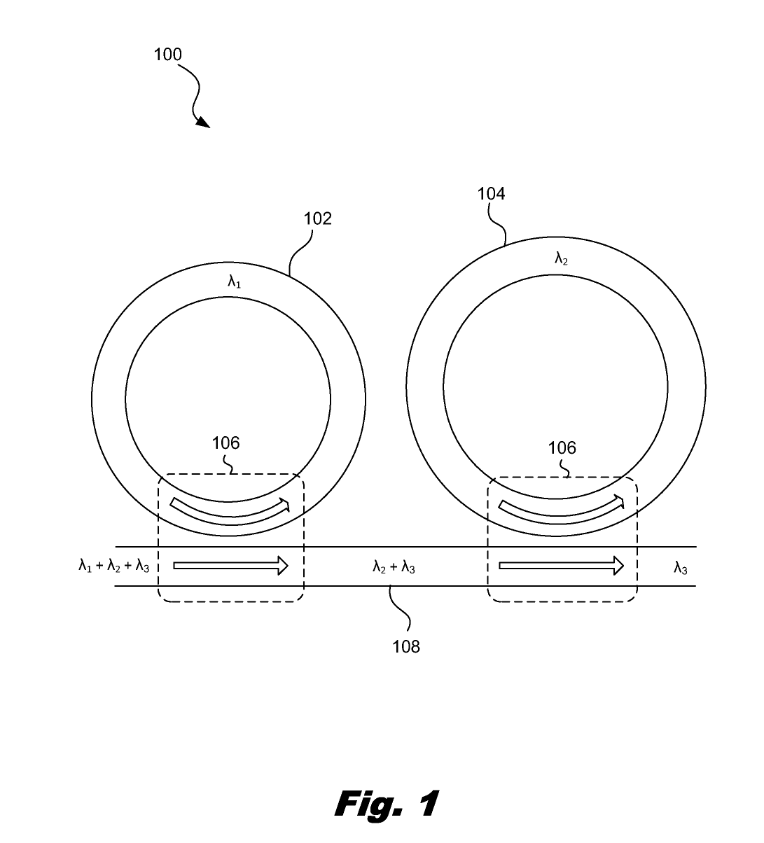

Referring now to the figures, FIG. 1 is a diagram showing illustrative micro-ring resonators (100). According to certain illustrative examples, micro-ring resonators (102, 104) are placed adjacent to a bus waveguide (108). Light propagating through the bus waveguide (108) can be evanescently coupled into the micro-ring resonators (102, 104) based on the state of those resonators.

As mentioned above, an optical waveguide is a structure that allows for the propagation of electromagnetic radiation having a wavelength in the optical range. The optical wavelengths range from 850 nm to 1650 nm. An optical waveguide includes a transparent material surrounded by a second transparent material with a lower refractive index. A refractive index is a characteristic of a material that indicates how light travels through that material.

Light traveling through one optical waveguide may be coupled into an adjacent optical waveguide. This phenomenon is referred to as evanescent coupling (106). As light propagates through the bus optical waveguide (108), it will be coupled into the micro-ring resonator, which is a circular optical waveguide. The length of the circular waveguide, which refers to the distance the light travels to make one full revolution around the circular waveguide, will help determine which wavelength of light will couple into that circular waveguide. This wavelength of light is said to be on resonance with the micro-ring. The length of the micro-ring resonator will be an integer multiple of the resonant wavelength of light that is coupled into that micro-ring.

In one example of FIG. 1, three wavelengths of light are propagated through the bus waveguide (108). These wavelengths are referred to as wavelength 1, wavelength 2, and wavelength 3. The length of the first micro-ring resonator (102) is such that wavelength 1 will couple into that micro-ring (102). Thus, wavelength 1 may be prevented from propagating through the bus waveguide by the first micro-ring resonator (102). The length of the second mirroring resonator (104) is such that wavelength 2 will be coupled into the micro-ring (104). Thus, wavelength 2 may be prevented from propagating through the bus waveguide by the second micro-ring resonator (104). In this example, wavelength 3 will always propagate through the bus waveguide because no micro-ring resonators are present to potentially remove wavelength 3. The micro-ring resonators (102, 104) thus act as filters to remove certain wavelengths of light propagating through the bus waveguide (108).

Micro-ring resonators can be used in photonic circuitry to allow certain wavelengths of light to represent a logical “1” or a logical “0”. For example, a particular bus optical waveguide may propagate four wavelengths of light, each wavelength representing a different bit. Four micro-ring resonators may be placed adjacent to that bus optical waveguide, each micro-ring resonator to remove a different wavelength of light. Those micro-ring resonators will determine which of the wavelengths of light will represent a logical “1” or a logical “0”. If a micro-ring resonator is “on”, then it will prevent propagation of its respective wavelength of the four wavelengths propagating through the bus waveguide. Conversely, if a micro-ring resonator is “off”, then it will allow propagation of its respective wavelength of light through the bus waveguide.

The process of switching a micro-ring resonator “on” or “off” is referred to as modulation. In its normal state, a micro-ring resonator is on and allows propagation through the length of its circular waveguide. However, certain conditions may be applied to the micro-ring resonator so that light will no longer be captured by the resonator. This turns the micro-ring resonator off, and thus its respective wavelength of light will pass through the bus optical waveguide (108) unobstructed.

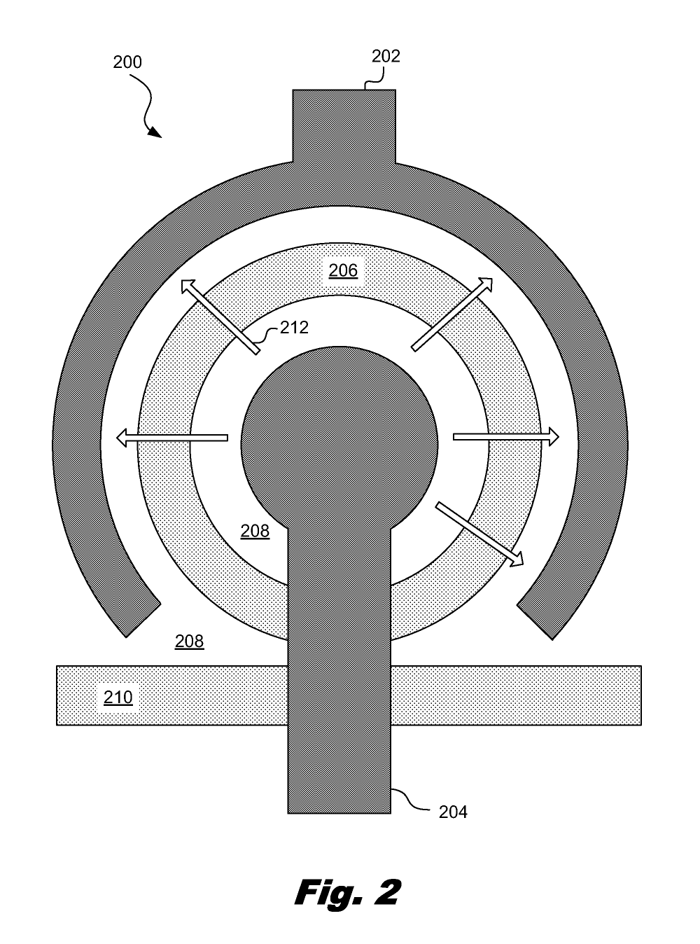

FIG. 2 is a diagram showing an illustrative top view of a polymer modulated micro-ring resonator (200). According to certain illustrative examples, the cladding of the circular waveguide of a micro-ring resonator may be made of an electro-optic polymer (208). As mentioned above, an electro-optic polymer is a material that changes its optical properties in response to an electrical condition. The refractive index of certain types of electro-optic polymers can be changed through application of an electrical field (212).

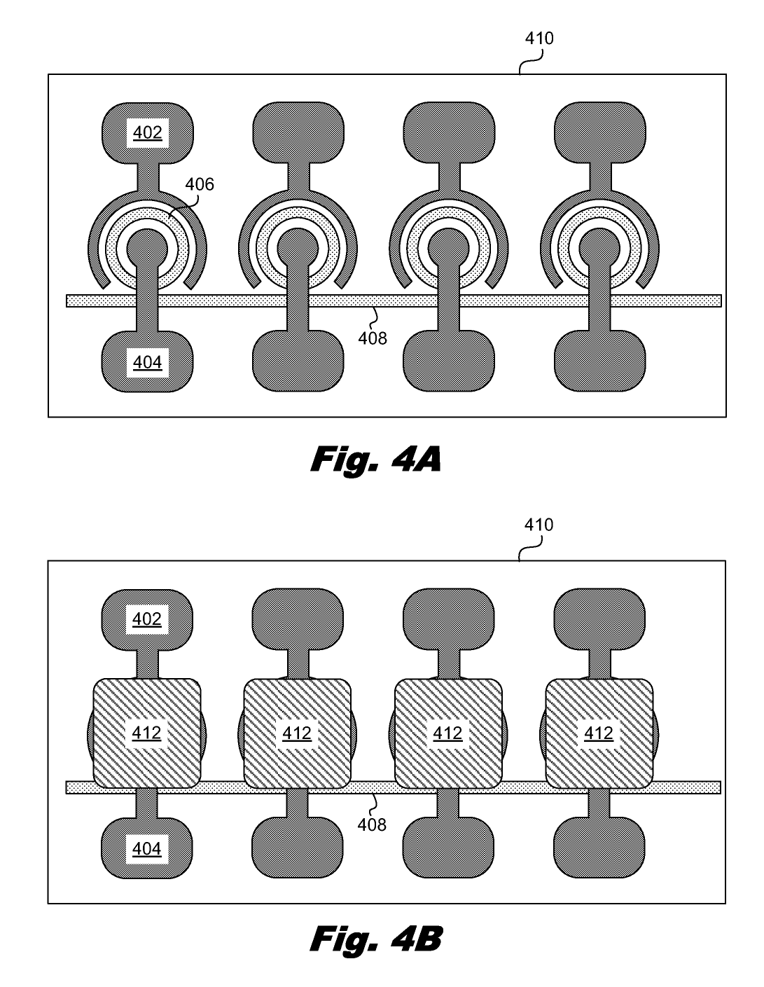

The inner material of the circular waveguide (206) may be a material such as silicon. Silicon may be patterned with a precision that allows propagation of certain wavelengths of light. These wavelengths of light are commonly used in photonic circuitry. After forming the silicon micro-rings onto a substrate, an electro-optic polymer (208) may be placed on top of the micro-rings to form a cladding. More detail on the process of fabricating a polymer modulated micro-ring resonator will be described below in the text accompanying FIGS. 4A and 4B.

According to certain illustrative examples, a first metal contact (202) is formed around the outer perimeter of the silicon micro-ring resonator. A second metal contact (204) is placed such that it extends from the center of the micro-ring (206) to the outer perimeter of the micro-ring (206). In some cases, the second metal contact may extend past the bus waveguide (210). The metal contacts may be formed out of any appropriate electrically conductive material. When a voltage is applied between the two metal contacts (202, 204), then an electric field (212) will form between the two metal contacts and across the electro-optic polymer (208) surrounding the micro-ring (206).

The application of the electric field (212) across the electro-optic polymer (208) will change the refractive index of the polymer (208) enough so that light at a particular frequency will no longer be captured by the micro-ring. The following equation describes the manner in which the refractive index is affected by the electric field.

dN=(1/2)*n³*r_{eff}*E (equation 1)

where:
dN=the change in refractive index of the electro-optic polymer;
n=the refractive index of the electro-optic polymer;
r_{eff}=the electro-optic coefficient; and
E=the strength of the electric field.

Certain electro-optic polymers have a high electro-optic coefficient and thus a smaller electric field is able to produce a greater change in the refractive index. The strength of the electric field is dependent on the strength of the voltage applied between the two metal contacts (202, 204). Thus, the electro-optic coefficient may be such that standard voltages associated with electronic circuitry are enough to change the refractive index enough to appropriately modulate the micro-ring. When the micro-ring is appropriately modulated, then light with the desired wavelength is no longer able to propagate through the micro-ring and thus the respective wavelength of light for that micro-ring will not be prevented from propagating through the bus waveguide (210).

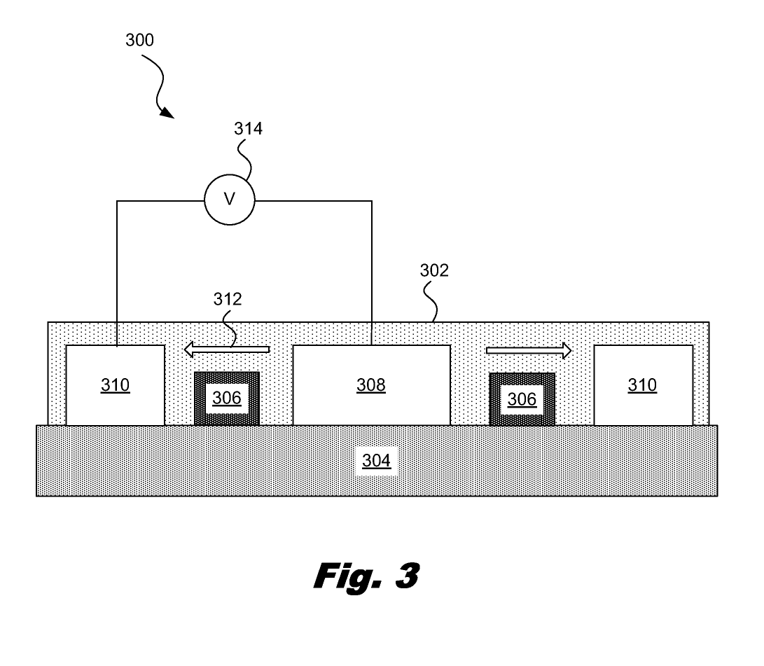

FIG. 3 is a diagram showing an illustrative cross sectional view (300) of the polymer modulated micro-ring resonator. According to certain illustrative examples, the micro-ring (306) is formed onto a substrate (304). The substrate may be made of a dielectric material such as silicon dioxide. The metal contacts (308, 310) are also formed onto the substrate (304). The electro-optic polymer (302) is then disposed on top of the micro-ring and metal contacts.

The electro-optic polymer does not need to be precisely placed around the surface of the micro-ring inner material. Rather, the electro-optic polymer is deposited on top of the micro-ring modulator in general. The metal contacts and the micro-ring may be formed during a standard integrated circuit fabrication process. The deposition of the electro-optic polymer at the back end of this process allows for a low cost fabrication process.

As mentioned above, application of a voltage (312) between the first metal contact (308) and the second metal contact (310) creates an electric field (312) across the electro-optic polymer (302). The electro-optic polymer (302) is not an electrically conductive material and thus there is very little electrical current flowing through the polymer (302). Because there is very little electrical current flowing, application of the voltage to create the electric field consumes very little power.

FIGS. 4A and 4B are diagrams showing an illustrative process for placing electro-optic polymer onto micro-ring resonators. FIG. 4A illustrates a top view of part of a photonic circuit before the electro-optic polymer has been deposited. According to certain illustrative examples, a number of micro-rings (406) are placed adjacent to the bus waveguide (408) onto a substrate (410). The length of each micro-ring (406) may be slightly different so that each micro-ring filters a different wavelength of light out of the bus waveguide (408).

FIG. 4B illustrates the top view of the photonic circuit after the electro-optic polymer (412) has been deposited on top of the micro-rings (406). The electro-optic polymer deposition may be large enough to cover the micro-ring (406). As mentioned above, the deposition of the electro-optic polymer does not have to be placed with such precision that it will only surround the micro-ring surface. Rather, the electro-optic polymer (412) may be deposited so that it covers part of the metal contacts (402). The metal contacts may be connected to external circuitry that will apply a voltage to create the electric field. Alternatively, the metal contacts may be connected to circuitry internal to the substrate (410) through switches. When the switches are on, a voltage is supplied between the metal contacts (402, 404). When the switches are off, then no voltage is applied between the metal contacts (402, 404).

In some cases, a micro-ring may not resonate at the desired frequency due to irregularities in the fabrication process. The desired frequency is one that will be propagating through the bus optical waveguide for modulation. For example, the bus optical waveguide may propagate four different specific wavelengths of light. Thus, four different micro-ring resonators will be used to filter out those wavelengths of light. The process of fabricating such small rings with precision is difficult and thus the ring may not always resonate at the frequencies of light that will be passing through the bus optical waveguide.

To compensate for this, a voltage can be applied across the circular optical waveguide in addition to the voltage used to modulate the micro-ring. This voltage will be referred to as a shifting voltage. A shifting voltage may be a Direct Current (DC) voltage. This will cause a DC electric field to be applied across the electro-optic polymer, thus changing the refractive index of the cladding. This change can be such that it shifts the resonant frequency to one of those which are propagating through the bus waveguide. This shifting voltage then remains in place while the modulating voltage is turned on and off at high frequencies.

In some cases, the shifting voltage, as part of the chip may be turned on and off at certain frequencies. These frequencies will generally be less than 1 MHz which is still relatively low compared to the 1 GHz frequencies used to modulate the micro-ring. In addition, the resonant frequency of a micro-ring resonator may drift in time based on temperature and other environmental factors. This DC electric field may be adjusted accordingly to compensate for such drifts.

The power used for maintaining the DC electric field is relatively low. The power consumed is a function of the capacitance between the electrodes, the voltage applied at the electrodes, and the frequency at which that voltage is switched. Because the applied DC voltage has a frequency of much less than 1 Megahertz (MHz), the power consumed remains small.

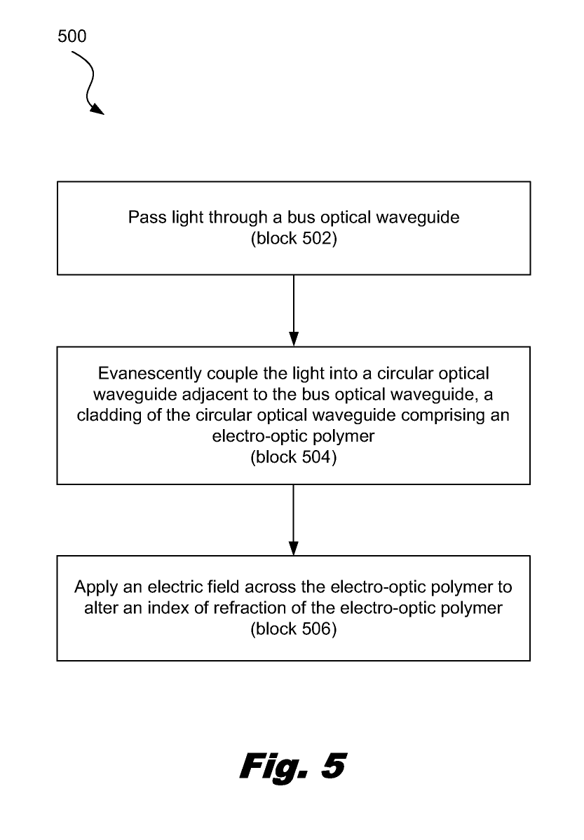

FIG. 5 is a flowchart showing an illustrative method for micro-ring resonator modulation. According to certain illustrative examples, the method includes passing (block 502) light through a bus optical waveguide, evanescently coupling (block 504) the light into a circular optical waveguide adjacent to the bus optical waveguide, a cladding of the circular optical waveguide comprising an electro-optic polymer, and applying (block 506) an electric field across the electro-optic polymer to alter an index of refraction of the electro-optic polymer.

In conclusion, through use of methods and systems embodying principles described herein, an efficient manner of modulating a micro-ring resonator may be realized. By modulating the resonator with an electric field, no electrical current will flow and thus very little power is consumed. By combining multiple resonators each operating at different wavelengths using WDM technology, the energy consumption per communication bandwidth is greatly reduced. Additionally, deposition of the electro-optical polymer is compatible with standard integrated circuit manufacturing processes and thus production of photonic circuits utilizing micro-ring resonators is made less costly.

The preceding description has been presented only to illustrate and describe examples of the principles described. This description is not intended to be exhaustive or to limit these principles to any precise form disclosed. Many modifications and variations are possible in light of the above teaching.

1. A micro-ring resonator comprising:
a bus optical waveguide; and
a circular optical waveguide positioned adjacent to said bus optical waveguide so as to provide evanescent coupling of light between said waveguides;
wherein a cladding of said circular optical waveguide comprises an electro-optic polymer with an index of refraction that can be changed through application of an electric field.

2. The resonator of claim 1, further comprising:
a first metal contact positioned on an outer perimeter of said circular optical waveguide; and
a second metal contact extending from a center of said circular optical waveguide to said outer perimeter of said circular optical waveguide.

3. The resonator of claim 2, further comprising, a voltage supply to supply a voltage between said first metal contact and said second metal contact, said voltage causing an electric field across said electro-optic polymer surrounding said circular optical waveguide.

4. The resonator of claim 1, wherein said bus optical waveguide and said circular optical waveguide are disposed onto a substrate and said electro-optic polymer is disposed on top of said circular optical waveguide.

5. The resonator of claim 1, further comprising a voltage supply to apply a shifting voltage to shift the resonant frequency of said circular optical waveguide.

6. The resonator of claim 5, in which a length of said circular optical waveguide is such that a wavelength of light passing through said bus optical waveguide will not propagate through said bus optical waveguide unless an electric field is applied across said electro-optic polymer surrounding said circular waveguide.

7. The resonator of claim 1, wherein said circular optical waveguide comprises silicon.

8. A method for modulating a micro-ring resonator, the method comprising:
passing light through a bus optical waveguide;
evanescently coupling said light into a circular optical waveguide adjacent to said bus optical waveguide, a cladding of said circular optical waveguide comprising an electro-optic polymer; and
applying an electric field across said electro-optic polymer to alter an index of refraction of said electro-optic polymer.

9. The method of claim 8, in which applying an electric field across said electro-optic polymer comprises:
applying a voltage between a first metal contact positioned on an outer perimeter of said circular optical waveguide and a second metal contact extending from a center of said circular optical waveguide to said outer perimeter of said circular optical waveguide.

10. The method of claim 9, wherein said voltage is of sufficient strength to cause said electric field to change said index of refraction enough to no longer allow light passing through said bus optical waveguide to propagate through said circular optical waveguide.

11. The method of claim 8, wherein said bus optical waveguide and said circular optical waveguide are disposed onto a substrate and said electro-optic polymer is disposed during a back end of a fabrication process.

12. The method of claim 8, in which a length of said circular optical waveguide is such that a wavelength of said light propagating through said bus optical waveguide will not propagate through said bus optical waveguide without said an electric field applied across said electro-optic polymer.

13. The method of claim 8, further comprising, applying a shifting voltage to said circular optical waveguide to shift the resonant frequency of said circular optical waveguide.

14. The method of claim 13, further comprising filtering said additional wavelengths of light with additional circular waveguides having a length to prohibit propagation of said additional wavelengths through said bus optical waveguide.

15. A photonic circuit comprising:
a bus optical waveguide;
multiple circular optical waveguides positioned adjacent to said bus optical waveguide so as to provide evanescent coupling between said bus optical waveguide and said circular optical waveguides lengths of said circular optical waveguides prohibiting wavelengths of light to be propagated through said bus optical waveguide;
an electro-optic polymer disposed around onto said circular optical waveguides to act as a cladding;
metal contacts surrounding said circular optical waveguides; and
a voltage supply to apply a voltage to said metal contacts to form an electric field across said electro-optic polymer, said electric field being of sufficient value to alter an index of refraction of said electro-optic polymer such that said circular waveguides are brought out of resonance.
